(19) United States
(12) Patent Application Publication
(10) Pub. No.: US 2008/0187749 A1
(43) Pub. Date: Aug. 7, 2008

(54) OPTICAL ELEMENT HAVING LIGHT INFLUENCING PROPERTY

(75) Inventors: John J. Cael, Upton, MA (US); Carol L. Knox, Monroeville, PA (US); Jonathan M. Mack, Boylston, MA (US); Feng Wang, Export, PA (US); Robert S. Wenzinger, Medina, OH (US)

Correspondence Address: Deborah M. Altman;PPG Industries, Inc., Law Department - Intellectual Property, One PPG Place- 39th Floor, Pittsburgh, PA, 15272-0001, US

(73) Assignee: PPG INDUSTRIES OHIO, INC., Cleveland, OH (US)

(21) Appl. No.: 11/955,725

(22) Filed: Dec. 13, 2007

Related U.S. Application Data
(60) Provisional application No. 60/884,424, filed on Jan. 11, 2007.
(60) Provisional application No. 60/956,204, filed on Aug. 16, 2007.

(51) Int. Cl. B32B 7/12

(52) U.S. Cl. 428/354

(57) ABSTRACT

Provided is an optical element having at least (a) a support polymeric film layer of film material having opposing first and second sides, (b) a second polymeric film layer having opposing first and second sides, the second layer including a film material exhibiting a light influencing property, and (c) optionally, an adhesive layer interposed between and connected to at least a portion of the first side of support layer (a) and the second side of second layer (b). The film material of support layer (a) and the film material of second layer (b) are the same or different.

### CROSS-REFERENCE TO RELATED APPLICATIONS

This application claims the benefit of priority of U.S. Provisional Patent Application No. 60/884,424, filed Jan. 11, 2007 and U.S. Provisional Patent Application No. 60/956,204 filed Aug. 16, 2007.

### FIELD OF THE INVENTION

The present invention relates to an optical element. More particularly, the present invention relates to an optical element comprised of multiple layers of polymeric film, one of which possesses a light-influencing property.

This application claims the benefit of priority of U.S. Provisional Patent Application No. 60/884,424, filed Jan. 11, 2007 and U.S. Provisional Patent Application No. 60/956,204 filed Aug. 16, 2007

The present invention is directed to an optical element comprising at least (a) a support polymeric film layer having opposing first and second sides, said polymeric film layer comprising a film material, (b) a second polymeric film layer having opposing first and second sides, said second polymeric film layer comprising a film material and exhibiting a light influencing property, and (c) optionally, an adhesive layer interposed between and connected to at least a portion of the first side of support polymeric film layer (a) and the second side of second polymeric film layer (b), wherein the film material comprising support polymeric film layer (a) and the film material comprising second polymeric film layer (b) are the same or different.

As used in this specification and the appended claims, the articles “a,” “an,” and “the” include plural referents unless expressly and unequivocally limited to one referent.

Additionally, for the purposes of this specification, unless otherwise indicated, all numbers expressing quantities of ingredients, reaction conditions, and other properties or parameters used in the specification are to be understood as being modified in all instances by the term “about.” Accordingly, unless otherwise indicated, it should be understood that the numerical parameters set forth in the following specification and attached claims are approximations. At the very least, and not as an attempt to limit the application of the doctrine of equivalents to the scope of the claims, numerical parameters should be read in light of the number of reported significant digits and the application of ordinary rounding techniques.

Further, while the numerical ranges and parameters setting forth the broad scope of the invention are approximations as discussed above, the numerical values set forth in the Examples section are reported as precisely as possible. It should be understood, however, that such numerical values inherently contain certain errors resulting from the measurement equipment and/or measurement technique.

As previously mentioned, the present invention is directed to an optical element comprising at least (a) a support polymeric film layer having opposing first and second sides, said layer comprising a film material, (b) a second polymeric film layer having opposing first and second sides, said second polymeric film layer comprising a film material and exhibiting a light influencing property, and optionally, (c) an adhesive layer interposed between and connected to at least a portion of the first side of support polymeric film layer (a) and the second side of second polymeric film layer (b), wherein the film material comprising support polymeric film layer (a) and the film material comprising second polymeric film layer (b) are the same or different. In one embodiment of the present invention, the support polymeric film layer (a) and the second polymeric film layer (b) comprise the same film material. In another embodiment, the support polymeric film layer (a) and the second polymeric film layer (b) comprise film materials that are different.

The term “light influencing property” or similar terms means that the indicated material, e.g., film layer, is capable of modifying by absorption (or filtering) of incident light radiation, e.g., visible, ultraviolet (UV) and/or infrared (IR) radiation that impinges on the material. In alternate embodiments, the light influencing property can be light polarization, e.g., by means of a polarizer and/or dichroic dye; a change in light absorption properties, e.g., by use of a chromophore that changes color upon exposure to actinic radiation, such as a photochromic material; transmission of only a portion of the incident light radiation, e.g., by use of a fixed tint such as a conventional dye; or by a combination of one or more of such light influencing functions.

As used herein the term “linearly polarize” means to confine the vibrations of the electric vector of light waves to one direction or plane. As used herein the term “dichroic” means capable of absorbing one of two orthogonal plane polarized components of at least transmitted radiation more strongly than the other. Thus, while dichroic materials are capable of preferentially absorbing one of two orthogonal plane polarized components of transmitted radiation, if the molecules of the dichroic material are not suitably positioned or arranged, no net linear polarization of transmitted radiation will be achieved. That is, due to the random positioning of the molecules of the dichroic material, selective absorption by the individual molecules will cancel each other such that no net or overall linear polarizing effect is achieved. Thus, it is generally necessary to suitably position or arrange the molecules of the dichroic material in order to achieve a net linear polarization.

As used herein the term “photochromic” means having an absorption spectrum for at least visible radiation that varies in response to at least actinic radiation. Thus, conventional photochromic elements are generally well suited for use in both low-light and bright conditions. It should be mentioned that conventional photochromic elements (that do not include linearly polarizing filters) are generally not adapted to linearly polarize radiation. That is, the absorption ratio of conventional photochromic elements, in either state, is generally less than two (2). As used herein the term “absorption ratio” refers to the ratio of the absorbance of radiation linearly polarized in a first plane to the absorbance of the same wavelength radiation linearly polarized in a plane orthogonal to the first plane, wherein the first plane is taken as the plane with the highest absorbance. Therefore, conventional photochromic elements typically cannot reduce reflected light glare to the same extent as conventional linearly polarizing elements.

As used herein the term “coating” means a supported polymeric layer derived from a flowable composition, which may or may not have a uniform thickness, and specifically excludes polymeric film as hereinafter defined. As used herein the term “polymeric film” means a pre-formed polymeric layer having a generally uniform thickness and capable of self-support (that is, it is free-standing) and specifically excludes coatings as defined above. Further, as used herein the term “connected to”, “appended to”, or like terms mean in direct contact with an object or indirect contact with an object through one or more other structures or materials or layers, at least one of which is in direct contact with the object.

As used herein the term “optical” means pertaining to or associated with light and/or vision. For example, the optical element or device can comprise ophthalmic elements and devices, display elements and devices, windows, mirrors, and/or active and passive liquid crystal cell elements and devices. As used herein the term “ophthalmic” means pertaining to or associated with the eye and vision. Non-limiting examples of ophthalmic elements include corrective and non-corrective lenses, including single vision or multi-vision lenses, which may be either segmented or non-segmented multi-vision lenses (such as, but not limited to, bifocal lenses, trifocal lenses and progressive lenses), as well as other elements used to correct, protect, or enhance (cosmetically or otherwise) vision, including without limitation, contact lenses, intra-ocular lenses, magnifying lenses, and protective lenses or visors. As used herein the term “display” means the visible or machine-readable representation of information in words, numbers, symbols, designs or drawings. Non-limiting examples of display elements and devices include screens, monitors, and security elements, such as security marks. As used herein the term “window” means an aperture adapted to permit the transmission of radiation there-through. Non-limiting examples of windows include automotive and aircraft transparencies, filters, shutters, and optical switches. As used herein the term “mirror” means a surface that specularly reflects a large fraction of incident light.

The support polymeric film layer (a) can comprise a polymeric film comprised of any of a wide variety of film materials, including thermoset and thermoplastic materials. For example, the support layer (a) can comprise polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, copolymers thereof, or mixtures thereof. In a particular embodiment of the present invention, the support polymeric film layer (a) can comprise cellulose acetate, cellulose diacetate, cellulose triacetate, cellulose acetate propionate, and/or cellulose acetate butyrate.

The support polymeric film layer (a) may further comprise any of a wide variety of additives to influence or enhance one or more of the processing and/or performance properties of the layer. Non-limiting examples of such additives can include dyes, photoinitiators, thermal initiators, polymerization inhibitors, solvents, light stabilizers (such as, but not limited to, ultraviolet light absorbers and light stabilizers, such as hindered amine light stabilizers (HALS)), heat stabilizers, mold release agents, rheology control agents, leveling agents (such as, but not limited to, surfactants), free radical scavengers, and adhesion promoters (for example, hexanediol diacrylate and/or coupling agents).

In a particular embodiment, the support polymeric film layer (a) may further comprise ultraviolet light absorber which can include, for example, 2-hydroxybenzophenones, 2-hydroxyphenylbenzotriazoles, oxalanilides, 2-hydroxyphenyltriazines, cinnamates, salicylates, and/or formamidines. Specific examples of suitable ultraviolet light absorbers can include those disclosed in U.S. Pat. No. 5,770,115 at column 4, lines 2-14, the cited portion of which is incorporated herein by reference. Suitable ultraviolet light stabilizers can include, but are not limited to those available from Ciba under the TINUVIN® tradename.

It should be mentioned that the support polymeric film layer (a) may be comprised of a single layer or ply of any one of the abovementioned materials, or the support polymeric film layer (a) may be comprised of multiple layers of any one of the abovementioned materials, or the support polymeric film layer (a) may be comprised of multiple layers of different materials such as any of those previously mentioned. The thickness of support polymeric film layer (a) can widely vary depending upon the type of material(s) comprising the support layer (a) and the desired end use of the optical element it comprises. Generally, the support polymeric film layer (a) has a thickness ranging from 10 to 2000 microns, such as from 20 to 1000 microns, or 50 to 500 microns, or 75 to 300 microns. The thickness of the support polymeric film layer (a) can range between any of the stated values, inclusive of the stated values.

The optical element of the present invention further comprises a second polymeric film layer (b) having opposing first and second sides and comprising a film material (as described herein). The second polymeric film layer (b) comprises a film that exhibits a light influencing property.

The second polymeric film layer (b) can comprise any of a wide variety of materials, for example, any of those materials previously described with respect to the support layer (a). In one embodiment of the present invention, the second polymeric film layer (b) is linearly polarizing. In such an embodiment, the second polymeric film layer (b) also may comprise a dichroic material as described hereinbelow, and may be oriented, as discussed hereinbelow, in one or more directions.

In a particular embodiment of the present invention, the second polymeric film layer (b) is linearly polarizing and comprises a polymeric component comprising poly(vinyl alcohol), poly(vinyl butyral), polyethylene terephthalate, cellulose acetate butyrate, cellulose diacetate, cellulose triacetate, polyurethane, polyether, polyester, polyamide, polyalkyl(meth)acrylate, mixtures thereof and/or copolymers thereof.

The second polymeric film layer (b) can be linearly polarizing and may comprise an optical film comprised of a disperse phase of polymeric particles disposed within a continuous birefringent matrix which film can oriented in one or more directions. The size and shape of the disperse phase particles, the volume fraction of the disperse phase, the film thickness and the amount of orientation are chosen to attain a desired degree of diffuse reflection and total transmission of radiation of a desired wavelength in the film. Such films and their preparation are described in U.S. Pat. No. 5,867,316 at column 6, line 47, to column 20, line 51, the cited portion of which is incorporated herein by reference. The second layer (b) when linearly polarizing also may comprise the birefringent multilayer optical films described in U.S. Pat. No. 5,882,774, at column 2, line 63, to column 18, line 31, the cited portion of which is incorporated herein by reference. Further, The second layer (b) also can comprise a two-component polarizer (i.e., dichroic and reflective polarizing components) such as that described in U.S. Pat. No. 6,096,375 at column 3, line 7 to column 19, line 46, the cited portion of which is incorporated herein by reference.

Further, the second polymeric film layer (b) can be linearly polarizing and can comprise oriented film of polyvinyl alcohol, vinyl butyral, polyethylene terephthalate, polyalkyl(meth)acrylate, polyamide, poly(amide-ether) block copolymers, poly(ester-ether) block copolymers, poly(ether-urethane) block copolymers, poly(ester-urethane) block copolymers, and/or poly(ether-urea) block copolymers. The term “oriented film” as used in conjunction with a linearly polarizing second polymeric film layer (b), means that the film has at least a first general direction (of alignment) such that one or more other structures or components comprising the sheet are positioned or suitably arranged along that same general direction. For example, the alignment or ordering of the dichroic compound along the long-axis of the dichroic compound is essentially parallel to at least the first general direction of the film or layer. As used herein with reference to order or alignment of a material or structure, the term “general direction” refers to the predominant arrangement or orientation of the material, compound or structure. Further, it will be appreciated by those skilled in the art that a material, compound or structure can have a general direction even though there is some variation within the arrangement of the material, compound or structure, provided that the material, compound or structure has at least one predominate arrangement.

The polarizing second polymeric film layer (b) may also comprise a “K-type” polarizer in which the dichroic material(s) are prepared, for example, by dehydration of poly(vinylalcohol). Such polarizers often are referred to as inherent polarizers since the absorbing chromophore is the result of conjugation in the polymer backbone, rather than due to dichroic materials, e.g., dichroic dyes, being added to the polymeric component. Such K-type polarizers can comprise a film of oriented poly(vinyl alcohol) having light polarizing (dichroic) molecules comprised of conjugated blocks, such as poly(acetylene) blocks (i.e., —[CH═CH—]ₙ), formed by heating the oriented poly(vinyl alcohol) film in the presence of a dehydration catalyst such as vapor of aqueous hydrochloric acid. K-type polarizers also can be formed by affixing an acid donor layer comprising a photoacid generator to the film of oriented poly(vinyl alcohol), and exposing to radiant energy at a temperature sufficient to effect partial dehydration of the vinylalcohol polymer to a vinylalcohol/poly(acetylene) copolymer. See, for example, U.S. Pat. No. 6,808,657.

As previously mentioned, the second polymeric film layer (b) when polarizing may comprise a dichroic material. Non-limiting examples of suitable dichroic materials can include, but are not limited to compounds such as azomethines, indigoids, thioindigoids, merocyanines, indans, quinophthalonic dyes, perylenes, phthaloperines, triphenodioxazines, indoloquinoxalines, imidazo-triazines, tetrazines, azo and (poly)azo dyes, benzoquinones, naphthoquinones, anthroquinone, (poly)anthroquinones, anthropyrimidinones, iodine, and/or iodates. As used herein the term “compound” means a substance formed by the union of two or more elements, components, ingredients, or parts and includes, without limitation, molecules and macromolecules (for example polymers and oligomers) formed by the union of two or more elements, components, ingredients, or parts.

The dichroic material also can comprise a polymerizable dichroic compound. That is, the dichroic material can comprise at least one group that is capable of being polymerized (i.e., a “polymerizable group”). For example, although not limiting herein, in one non-limiting embodiment the dichroic compound can have at least one alkoxy, polyalkoxy, alkyl, or polyalkyl substituent terminated with at least one polymerizable group.

The dichroic material also can comprise a photochromic-dichroic compound. The term “photochromic-dichroic” means displaying both photochromic and dichroic (i.e., linearly polarizing) properties under certain conditions, which properties are at least detectible by instrumentation. Accordingly, “photochromic-dichroic compounds” are compounds displaying both photochromic and dichroic (i.e., linearly polarizing) properties under certain conditions, which properties are at least detectible by instrumentation. Thus, photochromic-dichroic compounds have an absorption spectrum for at least visible radiation that varies in response to at least actinic radiation, and are capable of absorbing one of two orthogonal plane polarized components of at least transmitted radiation more strongly than the other (i.e., capable of exhibiting dichroism. Additionally, as with conventional photochromic compounds discussed hereinbelow, the photochromic-dichroic compounds disclosed herein can be thermally reversible. That is, the photochromic-dichroic compounds can switch from a first state to a second state in response to actinic radiation and revert back to the first state in response to thermal energy.

For example, according to various non-limiting embodiments disclosed herein, the photochromic-dichroic compound can have a first state having a first absorption spectrum, a second state having a second absorption spectrum that is different from the first absorption spectrum, and can be adapted to switch from the first state to the second state in response to at least actinic radiation and to revert back to the first state in response to thermal energy. Further, the photochromic-dichroic compound can be dichroic (i.e., linearly polarizing) in one or both of the first state and the second state. For example, although not required, the photochromic-dichroic compound can be linearly polarizing in an activated state and non-polarizing in the bleached or faded (i.e., not activated) state. As used herein, the term “activated state” refers to the photochromic-dichroic compound when exposed to sufficient actinic radiation to cause the at least a portion of the photochromic-dichroic compound to switch from a first state to a second state. Further, although not required, the photochromic-dichroic compound can be dichroic in both the first and second states. While not limiting herein, for example, the photochromic-dichroic compound can linearly polarize visible radiation in both the activated state and the bleached state. Further, the photochromic-dichroic compound can linearly polarize visible radiation in an activated state, and can linearly polarize UV radiation in the bleached state.

Examples of photochromic-dichroic compounds suitable for use in the present invention can include, but are not limited, to those described in detail in U.S. Patent Application Publication No. 2005/0012998A1 at paragraphs [0089] to [0339], which disclosure is incorporated herein by reference.

As previously mentioned, the second polymeric film layer (b) can be polarizing and can comprise an oriented polymeric film. The polymeric components and the dichroic material(s) (including dichroic-photochromic materials as described above) used to prepare such polymeric film(s), and any other components which may be included, can be blended together and then subjected to any of a variety of processing techniques known in the art to form the film. Such techniques can include, for example, extrusion, solvent casting, calendering, blowing, molding, or combinations of such techniques. Alternatively, the composition used to prepare the polymeric component can be blended together and subjected to any of a variety of processing techniques known in the art to form the film. Once the film is formed, a solution comprising the dichroic material(s) can be incorporated into the film, such as by an imbibition process well know in the art, and the imbibed film then can be oriented to align the dichroic material(s).

The film can be fixed in the oriented configuration by any of a variety of fixing means known in the art. For example, a film oriented by stretching can be fixed in the oriented configuration to prevent recovery of the sheet to the pre-stretched configuration by mechanically fixing means (such as by the use of clamps). Other means can include thermofixing or thermal annealing, i.e., fixing the oriented film by heating. Where the film is prepared from reactive (e.g., crosslinkable) polymeric components, the film can be formed, such as by extrusion or solvent casting, in such a way that the components do not react. Once formed, the film can be oriented then fixed in the oriented configuration by reacting (e.g., crosslinking, including self-crosslinking) the polymeric components. For example, such crosslinking can be effectuated by subjecting the oriented film to conditions which promote the reaction of the functional groups of any reactive polymeric components, e.g., subjecting the oriented sheet to heat or radiation including actinic (ultraviolet) and/or ionizing (electron beam) radiation.

Further, as previously mentioned, the second polymeric film layer (b) can be photochromic. That is, the second polymeric film layer (b) can comprise a photochromic material (either in addition to or in lieu of a photochromic-dichroic material as described above). As used herein, the term “photochromic material” includes both thermally reversible and non-thermally reversible (or photo-reversible) photochromic compounds. Generally, although not limiting herein, when two or more photochromic materials are used in conjunction with each other or with a photochromic-dichroic compound (such as those described above), the various materials can be chosen to complement one another to produce a desired color or hue. For example, mixtures of photochromic compounds can be used according to certain non-limiting embodiments disclosed herein to attain certain activated colors, such as a near neutral gray or near neutral brown. See, for example, U.S. Pat. No. 5,645,767, column 12, line 66 to column 13, line 19, the disclosure of which is specifically incorporated by reference herein, which describes the parameters that define neutral gray and brown colors.

The photochromic material can comprise any of a variety of organic and inorganic photochromic materials. The photochromic material(s) can include but is not limited to the following classes of materials: chromenes, e.g., naphthopyrans, benzopyrans, indenonaphthopyrans, phenanthropyrans or mixtures thereof; spiropyrans, e.g., spiro(benzindoline)naphthopyrans, spiro(indoline)benzopyrans, spiro(indoline)naphthopyrans, spiro(indoline)quinopyrans and spiro(indoline)pyrans; oxazines, e.g., spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates, fulgides, fulgimides and mixtures of such photochromic compounds.

Such photochromic materials and complementary photochromic materials are described in U.S. Pat. No. 4,931,220 at column 8, line 52 to column 22, line 40; U.S. Pat. No. 5,645,767 at column 1, line 10 to column 12, line 57; U.S. Pat. No. 5,658,501 at column 1, line 64 to column 13, line 17; U.S. Pat. No. 6,153,126 at column 2, line 18 to column 8, line 60; U.S. Pat. No. 6,296,785 at column 2, line 47 to column 31, line 5; U.S. Pat. No. 6,348,604 at column 3, line 26 to column 17, line 15; and U.S. Pat. No. 6,353,102 at column 1, line 62 to column 11, line 64, the disclosures of the aforementioned patents are incorporated herein by reference. Spiro(indoline)pyrans are also described in the text, Techniques in Chemistry, Volume III, “Photochromism”, Chapter 3, Glenn H. Brown, Editor, John Wiley and Sons, Inc., New York, 1971.

In a further non-limiting embodiment, the photochromic materials can be polymerizable photochromic materials, such as polymerizable naphthoxazines disclosed in U.S. Pat. No. 5,166,345 at column 3, line 36 to column 14, line 3; polymerizable spirobenzopyrans disclosed in U.S. Pat. No. 5,236,958 at column 1, line 45 to column 6, line 65; polymerizable spirobenzopyrans and spirobenzothiopyrans disclosed in U.S. Pat. No. 5,252,742 at column 1, line 45 to column 6, line 65; polymerizable fulgides disclosed in U.S. Pat. No. 5,359,085 at column 5, line 25 to column 19, line 55; polymerizable naphthacenediones disclosed in U.S. Pat. No. 5,488,119 at column 1, line 29 to column 7, line 65; polymerizable spirooxazines disclosed in U.S. Pat. No. 5,821,287 at column 3, line 5 to column 11, line 39; polymerizable polyalkoxylated naphthopyrans disclosed in U.S. Pat. No. 6,113,814 at column 2, line 23 to column 23, line 29; and the polymerizable photochromic compounds disclosed in WO97/05213 and in U.S. Pat. No. 6,555,028 at column 1, line 16 to column 24, line 56. The disclosures of the aforementioned patents on polymerizable photochromic materials are incorporated herein by reference.

Other suitable photochromic materials can include organo-metal dithiozonates, e.g., (arylazo)-thioformic arylhydrazidates, e.g., mercury dithizonates which are described in, for example, U.S. Pat. No. 3,361,706 at column 2, line 27 to column 8, line 43; and fulgides and fulgimides, e.g., the 3-furyl and 3-thienyl fulgides and fulgimides, which are described in U.S. Pat. No. 4,931,220 at column 1, line 39 through column 22, line 41, the disclosures of which are incorporated herein by reference.

Further photochromic material can include organic photochromic material resistant to the effects of a polymerization initiator when used. Such organic photochromic materials include photochromic compounds in admixture with a resinous material that has been formed into particles and encapsulated in metal oxides, which are described in U.S. Pat. Nos. 4,166,043 and 4,367,170 at column 1, line 36 to column 7, line 12, which disclosure is incorporated herein by reference.

The photochromic material can comprise a single photochromic compound; a mixture of photochromic compounds; a material comprising at least one photochromic compound, such as a plastic polymeric resin or an organic monomeric or oligomeric solution; a material such as a monomer or polymer to which at least one photochromic compound is chemically bonded; a material comprising and/or having chemically bonded to it at least one photochromic compound, the outer surface of the material being encapsulated (encapsulation is a form of coating), for example with a polymeric resin or a protective coating such as a metal oxide that prevents contact of the photochromic material with external materials such as oxygen, moisture and/or chemicals that have a negative effect on the photochromic material, such materials can be formed into a particulate prior to applying the protective coating as described in U.S. Pat. Nos. 4,166,043 and 4,367,170; a photochromic polymer, e.g., a photochromic polymer comprising photochromic compounds bonded together; or mixtures thereof.

Suitable photochromic materials also can include the polymerizable polyalkoxylated naphthopyrans disclosed in U.S. Pat. No. 6,113,814, at column 2, line 24 to column 23, line 29, the cited portions of which are incorporated herein by reference. Additionally, suitable photochromic materials can include polymeric matrix compatibilized naphthopyran compounds such as those disclosed in U.S. Pat. No. 6,555,028B2 at column 2, line 40 to column 24, line 56, the cited portions of which are incorporated herein by reference.

Further, in a particular embodiment of the present invention, the photochromic material can comprise a reaction product of at least one ring-opening cyclic monomer comprising a cyclic ester and/or a cyclic carbonate, and a photochromic initiator. Such materials and the preparation thereof are described in detail in U.S. Patent Application Publication No. 2006/0022176A1 at paragraphs to [0088], the cited portions of which are incorporation herein by reference.

To enhance kinetics of any photochromic materials present in any of layers (a) and/or (b), and/or layer (c) and/or (d) (as hereinafter described), one or more art recognized plasticizers also may be used in conjunction with the photochromic material. Suitable plasticizers useful in the present invention can include the generally known classes of plasticizers. Examples of the classes of plasticizers are listed in Table 117, Chemical Names of Plasticizers and their Brand Names, pp 140-188, of Plasticizer Evaluation and Performance by Ibert Mellan, Noyes Development Corporation, 1967; in Ullmann's Encyclopedia of Industrial Chemistry, Vol. 20, pp 439-458, 1992, and in Modern Plastics Encyclopedia, Mid-November 1998 Issue, volume 75, Number 12, pages C-105 to C-115.

The various classes of plasticizers contemplated for use herein can include, but are not limited to: abietates, e.g. methyl abietate; acetates, e.g., glycidyl triacetate; adipates, e.g., dibutyl adipate; azelates, e.g., diisoocytyl azelate; benzoates, e.g., polyethyleneglycol dibenzoate; biphenyls, e.g., camphor; caprylates, e.g., butanediol dicaprylate; citrates, e.g., triethyl citrate; dodecanedioates, e.g., dioctyl dodecanedioate; ethers, e.g., dibenzyl ether; fumarates, e.g., diocytyl fumarate; glutarates, e.g., diisodecyl glutarate; glycolates, e.g., di(2-ethylhexyl)diglycolate; isophthalate, e.g., dimethyl isophthalate; laurates, e.g., poly(ethylene glycol)monolaurate; maleates, e.g., dibutyl maleate; myristates, e.g., isopropyl myristate; oleates, e.g., methyloleate; palmitates, e.g., tetrahydrofurfuryl palmitate; paraffin derivatives, e.g., chlomenate paraffin; phosphates, e.g., 2-ethylhexyl diphenyl phosphate and triphenyl phosphate; phthalates, e.g., diethyl phthalate and dioctyl phthalate; ricinoleates, e.g., methoxyethyl ricinoleate; sebacates, e.g., diethyl sebacate; stearates, e.g., methylpentachlorostearate; sulfonamides, e.g., toluene sulfonamide; tartrates, e.g., butyl tartrates; terephthalates, e.g., dioctyl terephthalate; trimellitates, e.g., trioctyl trimellitate and mixtures of such plasticizers.

Examples of suitable plasticizers also can include, where appropriate, organic polyols such as: polyester polyols; polyether polyols; amide-containing polyols; polyhydric polyvinyl alcohols; and mixtures of such polyols. Such organic polyols and their preparation are well known in the art.

The second polymeric film layer (b) also may comprise, where appropriate, any of a variety of additives such as any of those previously discussed with respect to support polymeric film layer (a). In a particular embodiment the second polymeric film layer (b) may also comprise a stabilizer such as a light stabilizer and/or an antioxidant. Suitable stabilizers can include, but are not limited to the hindered amine light stabilizers available from Ciba under the tradename “TINUVIN®” (e.g., TINUVIN 111, TINUVIN 123, TINUVIN 144, TINUVIN 765 and/or TINUVIN 770), and antioxidants such as those available from Ciba under the tradename IRGANOX® (e.g., IRGANOX 1010, IRGANOX 1035, IRGANOX 1076, IRGANOX 1081, IRGANOX 1135 and/or IRGANOX 1330).

The second polymeric film (b) may be comprised of a single layer or ply of any of the abovementioned materials, or the second polymeric film layer (b) may be comprised of multiple layers of one of the abovementioned materials, or the second polymeric film layer (b) may be comprised of multiple layers of different materials. The thickness of the second polymeric film layer (b) can widely vary depending upon the type of material(s) comprising the second polymeric film layer (b) and the desired end use of the optical element it comprises. Generally, the thickness of the second polymeric film layer (b) can range from 5 to 1000 microns, such as from 5 to 500 microns, or from 7 to 200 microns, or from 10 to 100 microns, or from 10 to 75 microns. The thickness of the second polymeric film layer (b) can range between any of the stated values, inclusive of the stated values.

Optionally, the optical element of the present invention can further comprise an adhesive layer (c) interposed between and connected to at least a portion of the first side of support polymeric film layer (a) and the second side of the second polymeric film layer (b). The optional adhesive layer (c) can comprise any of a wide variety of adhesive materials known in the art provided such adhesive materials do not adversely affect the optical qualities (e.g., clarity) of the resulting optical element.

For example, pressure sensitive adhesive material can be used to form the adhesive layer (c), including self-tacky adhesives or those requiring the addition of a tackifier. Such materials can include, but are not limited to tackified natural rubbers, tackified synthetic rubbers, tackified styrene block copolymers, self-tacky or tackified acrylate or methacrylate copolymers, self-tacky or tackified poly olefins, and tackified silicones. Non-limiting examples of suitable pressure sensitive adhesives include those described in the Encylopedia of Polymer Science and Engineering, vol. 13, Wiley-Interscience Publishers, New York, 1988, the Encyclopedia of Polymer Science and Technology, vol. 1, Interscience Publishers, New York, 1964; and Handbook of Pressure Sensitive Adhesives, D. Satas, Editor, 2^{nd} Edition, Von Nostrand Reinhold, New York, 1989. Suitable pressure sensitive adhesives can include those sold under the tradename DURO-TAK® commercially available from National Starch & Chemical.

Other suitable adhesives can include, but are not limited to curable flexible laminating adhesives such as OP-40, OP-44 ULTRA FAST™, and OP-44 ULTRA FAST™ photocurable adhesives commercially available from Dymax Corporation of Torrington, Conn.; and OPT 5053, OPT 5001, and OPT 5012 epoxy-based adhesives commercially available from Intertronic of Oxfordshire, England.

It should be noted that in an embodiment of the present invention, the second polymeric film layer (b) can be connected directly to the support polymeric film layer (a) with no intervening adhesive layer (c). In such an embodiment, first side of support polymeric film layer (a) is connected directly to the second side of second polymeric film layer (b) by means other than by adhesive bonding through the use of adhesive materials. For example, the layers may be connected by at least one of laminating, fusing, and in-mold casting, the second polymeric film layer (b) to at least a portion of the support polymeric film layer (a).

The optical element of the present invention also may comprise a protective polymeric film layer (d) having opposing first and second sides, wherein the second side of protective polymeric film layer (d) is connected to at least a portion of the first side of the second polymeric film layer (b). The protective polymeric film layer (d) can comprise any of a wide variety of polymeric materials including any of those discussed above with respect to support polymeric film layer (a) and, where appropriate, the second polymeric film layer (b). For example, protective polymeric film layer (d) can comprise polycarbonate, cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polyurethane, poly(urea)urethane, polythiourethane, polythio(urea)urethane, polysulfone, polyolefin, copolymers thereof, and/or mixtures thereof.

The protective polymeric film layer (d) may further comprise any of a wide variety of additives to influence or enhance one or more of the processing and/or performance properties of the layer. Non-limiting examples of such additives can include any of those previously mentioned with respect to the support polymeric film layer (a).

It should be mentioned that the protective polymeric film layer (d) may be comprised of a single layer or ply of any of the abovementioned materials, or the protective polymeric film layer (d) may be comprised of multiple layers of one of the abovementioned materials, or the protective polymeric film layer (d) may be comprised of multiple layers of different materials. The thickness of protective polymeric film layer (d) can widely vary depending upon the type of material(s) comprising the protective polymeric film layer (d) and the desired end use of the optical element it comprises. Generally, the protective polymeric film layer (d) has a thickness ranging from 10 to 2000 microns, such as from 20 to 1000 microns, or 50 to 500 microns, or 75 to 300 microns. The thickness of the protective polymeric film layer (d) can range between any of the stated values, inclusive of the stated values.

The protective polymeric film layer (d) and the second polymeric film layer (b) may be connected by any means known in the art, provided, of course, the optical and other physical properties of the optical element are not negatively affected. For example the layers (d) and (b) can be connected by any of the art-recognized laminating, fusing, adhesively bonding, and/or in-mold casting processes.

In any of the optical elements of the present invention, the support polymeric film layer (a) and/or the optional adhesive layer (c) and/or the protective polymeric film layer (d) can comprise a photochromic material.

As previously mentioned, the optical element of the present invention can comprise (a) a support layer having opposing first and second sides; (b) a linearly polarizing layer having opposing first and second sides; (c) optionally, an adhesive layer interposed between and connected to at least a portion of the first side of support layer (a) and the second side of polarizing layer (b); and (d) a protective layer having opposing first and second sides, wherein the second side of protective layer (d) is connected to at least a portion of the first side of polarizing layer (b), and wherein at least one of (a), (b) and (d) comprises a photochromic material. In one such embodiment, the protective layer (d) comprises photochromic material, and support layer (a) is free of photochromic material, and polarizing layer (b) is free of photochromic material.

In a non-limiting embodiment of the present invention, the optical element does not comprise a protective film layer (d) and the second polymeric film layer (b) further comprises a protective coating applied to at least a portion of the first side of the second polymeric film layer (b). The protective coating can comprise, for example, abrasion-resistant coatings, oxygen barrier-coatings, UV-shielding coatings, anti-reflective coatings, anti-fogging coatings, mirror coatings, or combinations thereof, connected to at least a portion of the first side of the second film layer (b).

Where the optical element comprises a protective film layer (d), the protective film layer (d) can further comprise a protective coating applied to at least a portion of the first side of the protective film layer (d). The protective coating can comprise any of those mentioned immediately above.

The optical element of the present invention can be used as or as a component in ophthalmic elements and devices, display elements and devices, windows, mirrors, and/or active and passive liquid crystal cell elements and devices (all of which are described above) to provide both photochromic and polarizing properties to such elements and devices.

The invention is further described in conjunction with the following examples, which are to be considered as illustrative rather than limiting, and in which all parts are parts by weight and all percentages are percentages by weight unless otherwise specified.

### EXAMPLES

### Example 1

### Step 1—Triacetyl Cellulose Solution Preparation

A triacetyl cellulose (TAC) solution was prepared by adding TAC, 20 weight percent based on the total weight percent of the mixture, to a vessel equipped with a mixer and heater containing methylene chloride. Note that all weight percent values reported herein are based on the total weight of the mixture, solution or resin unless stated otherwise. The resulting mixture was heated with stirring at 50° C. until the TAC was dissolved. Triphenylphosphate (15 weight percent based on the TAC solids level) was added with mixing.

### Step 2—Addition of Photochromic Dyes

The mixture of photochromic dyes (0.15 weight percent based on the weight of the TAC solids) listed below were added to the solution of Step 1 with mixing.

| | Weight Percent of |
|---|---|
| Photochromic Dye | Total Dye Mixture |
| Photochromic A ⁽¹⁾ | 50 |
| Photochromic B ⁽²⁾ | 30 |
| Photochromic C ⁽³⁾ | 20 |

⁽¹⁾ Photochromic A is an indenonaphthopyran reported to produce a blue activated color.
⁽²⁾ Photochromic B is an indenonaphthopyran reported to produce a greenish activated color.
⁽³⁾ Photochromic C is an indenonaphthopyran reported to produce a reddish brown activated color.

### Step 3—Preparation of Photochromic TAC Film

The photochromic TAC solution from Step 2 was cast onto a glass plate with a 16 mil draw down bar. Two to three castings were made to produce a film having a thickness of about 3 mils after evaporation of the methylene chloride in a oven maintained at 60° C.

### Example 2

The procedure of Example 1 was followed except that cellulose acetate butyrate (CAB) was used in place of TAC; acetone was used in place of methylene chloride; and TPP was used at a 20 percent level based on the solids weight of CAB.

### Example 3

The procedure of Example 1 was followed except that cellulose diacetate (CDA) was used in place of TAC; and acetone was used in place of methylene chloride.

### Example 4

### Step 1—Preparation of a Cellulose Diacetate Solution

The procedure of Example 1 Step 1 was followed except that cellulose diacetate (CDA) solution was used in place of TAC; acetone was used in place of methylene chloride; TPP was used at a 20 percent level based on the solids weight of CAB; and a light stabilizer of the hindered amine class (HALS) was used at weight ratio of 4:1 of the photochromic dyes.

### Step 2—Addition of Photochromic Dyes

The procedure of Example 1 Step 2 was followed.

### Step 3—Preparation of Photochromic CDA Film

The photochromic CDA solution from Step 2 was cast onto a stainless steel belt to produce a film having a thickness of about 7 mils after evaporation of the acetone.

### Step 4—Lamination Step

The photochromic CDA film from Step 3 was used with other films to form a laminated photochromic and polarizing sample. The order of the films was as follows:

#1—A 7 mil clear CDA film.

#2—The photochromic 7 mil CDA film of Step 3.

#3—An iodine treated polarizing stretched polyvinyl alcohol film.

#4—A 14 mil clear CDA film prepared by laminating two 7 mil films.

#5—A 14 mil clear CDA film. prepared by laminating two 7 mil films.

Each of the CDA films used in the above laminate except the #1 and #2 films contained uv absorbers that provided the film with a transmittance at 400 nanometers of approximately 1 percent or less.

The #1 film and the #2 film were laminated using acetone to cause adhesion. Lamination was done by running a pair of CDA films between a pair of nip rollers with a bead of acetone spread between the interfaces of the two films. The contact time for the acetone and two CDA films was less than a second. The exterior of the #1 film was coated with an ultraviolet (uv) curable acrylic-based optical quality hardcoat available from Exopack, LLC Corp, to produce a hardcoat having a thickness of approximately 4 microns. The surface of the #2 film was subjected to a hydrolysis treatment as follows: immersed for 15 seconds in 20 weight percent sodium hydroxide at 120° F. (49° C.); immersed for 20-25 seconds in water at 70-75° F. (21-24° C.) and dried for 35-40 seconds at 150-155° F. (65-68° C.).

The resulting composite was laminated to the #3 film, a polyvinyl alcohol film that was being stretched 4 times as it was being laminated to the #2 film. An aqueous 5 weight percent solution of CELVOL® 205, reported to be a partially hydrolyzed polyvinyl alcohol, was used to cause adhesion between the #2 and #3 films as they were laminated and rolled up in the same manner as was done with the acetone.

The exterior surface of the #3 film was treated to make it polarizing by the following: immersion for 10 to 11 seconds in a first aqueous solution of iodine (0.32 weight percent) and potassium iodide (8.6 weight percent) maintained at 70° F. (21° C.); immersion for 4 seconds in water maintained at a temperature of 60-70° F. (16-21° C.); immersion for 10-11 seconds in a second aqueous solution of boric acid (7.5 weight percent) and potassium iodide (3.3 weight percent) maintained at a temperature of 125° F. (52° C.); immersion for 4 seconds in water maintained at 60-70° F. (16-21° C.); and dried for 35-40 seconds at 150-155° F. (65-68° C.). Prior to lamination of the composite of films #1-3 to the #4 and # 5 films, both the #4 and 5 films were subjected to the hydrolysis treatment described above. The composite of films # 1-3 was laminated to the #4 film using the previously described 5 weight percent aqueous solution of CELVOL® 205 and subsequently laminated to the #5 film using the same process.

### Photochromic Example Testing

The photochromic and photochromic and polarizing laminated test sample prepared in Examples 1-4 were cut into squares about 5 by 5 centimeters and tested for photochromic response as described herein on a Bench for Measuring Photochromics (BMP) optical bench made by Essilor, France.

Prior to testing on the optical bench, each photochromic test sample was exposed to 365 nanometer ultraviolet light for about 10 minutes at a distance of about 14 centimeters to activate the photochromic compounds. The UVA (315 to 380 nm) irradiance at the sample was measured with a Licor Model Li-1800 spectroradiometer and found to be 22.2 watts per square meter. The test samples were placed under a high intensity halogen lamp for about 10 minutes at a distance of about 36 centimeters to bleach (inactivate) the photochromic compounds. The illuminance at the samples was measured with the Licor spectroradiometer and found to be 21.9 Klux. Each test sample was then kept covered for at least 1 hour prior to testing on an optical bench.

The BMP comprises a flat metal surface to which was fitted two 150 watt Xenon arc lamps positioned 90° apart (one lamp to provide UV/VIS light and one to provide the additional contribution of visible light). The somewhat collimated output beams from the xenon arc lamps were combined and directed toward the sample cell and toward irradiance detectors through a 50/50 beam splitter. Each lamp was filtered and shuttered individually and also shuttered after blending, prior to entering the sample cell. Each lamp was filtered with a Schott 3 mm KG-2 band-pass filter. The lamp for supplemental visible light was additionally filtered with a 400 nm cutoff filter.

The software supplied with the equipment, i.e., BMPSoft version 4.0c, was used to control timing, irradiance, air cell and sample temperature, shuttering, filter selection and response measurement. The software program provided for irradiance adjustments within established set limits through a photofeedback unit, that in turn, made slight adjustments to the lamp wattage and subsequent lamp output. If a selected irradiance could not be achieved within the limits of the ZEISS spectrophotometer, the program indicated the need for a change in selection of neutral density filters for each light path. Photopic response measurements were collected since multiple photochromic compounds were used in the laminate.

Set up of the BMP software required correlation factors between spectroradiometric measurements at the sample with a ZEISS spectrophotometer Model MCS 501. The BMP software used the correlation factors to set the operating irradiance on the optical bench. The test sample cell was fitted with a quartz window and self-centering sample holder. The temperature in the sample cell was controlled at 23° C. through the software with a modified Facis, Model FX-10, environment simulator.

The power output of the optical bench, e.g., the dosage of light that the test sample would be exposed to, was adjusted to 6.7 Watts per square meter (W/m²). Visible light output was always maintained at 50 kilolux. A Zeiss spectrophotometer, Model MCS 501, with fiber optic cables for light delivery from a tungsten halogen lamp and through the sample was used for photochromic response and color measurements. The collimated monitoring light beam from the fiber optic cable was maintained perpendicular to the test sample while passing through the sample and directed into a receiving fiber optic cable assembly attached to the spectrophotometer. The exact point of placement of the sample in the sample cell was where the activating xenon arc beam and the monitoring light beam intersected to form two concentric circles of light. The angle of incidence of the xenon arc beam at the sample placement point was ≈20° from perpendicular.

Response measurements, in terms of a change in optical density (ΔOD) from the unactivated or bleached state to the activated or darkened state were determined by establishing the initial unactivated transmittance, opening the shutter from the Xenon lamp(s) and measuring the transmittance through activation at selected intervals of time. Change in optical density is determined according to the formula: ΔOD=log(% Tb % Ta), where % Tb is the percent transmittance in the bleached state, % Ta is the percent transmittance in the activated state and the logarithm is to the base 10. Optical density measurement was done at the photopic wavelength. The percent transmittance in the bleached state (% Tb) and in the activated state (% Ta) are listed in Table 1.

The Fade Half Life (T1/2) is the time interval in seconds for the ΔOD of the activated form of the photochromic material in the test squares to reach one half the ΔOD measured after fifteen minutes of activation at 23° C., after removal of the source of activating light, e.g., by closing the shutter.

The results for Examples 1-3 prepared from single photochromic films are not expected to change when assembled in a composite of at least one clear film. If assembled in a composite such as Example 4, the photochromic Fade Half Life results are not expected to change, but the percent transmittance is expected to be different.

TABLE 1
Photochromic Performance and Percent
Transmittance (Activated & Bleached)

| Example # | % Tb | % Ta | T½ |
|---|---|---|---|
| 1 | 81 | 22 | 80 seconds |
| 2 | 81 | 10 | 100 seconds |
| 3 | 90 | 30 | 125 seconds |
| 4 | 40 | 16 | 80 seconds |

Although the present invention has been described with reference to specific details of certain embodiments thereof, it is not intended that such details should be regarded as limitations upon the scope of the invention except insofar as they are included in the accompanying claims.

Therefore, we claim:

1. An optical element comprising at least
(a) a support polymeric film layer having opposing first and second sides, said layer comprising a film material,
(b) a second polymeric film layer having opposing first and second sides, said second layer comprising a film material and exhibiting a light influencing property, and
(c) optionally, an adhesive layer interposed between and connected to at least a portion of the first side of support polymeric film layer (a) and the second side of second polymeric film layer (b), wherein the film material comprising support polymeric film layer (a) and the film material comprising second polymeric film layer (b) are the same or different.

2. The optical element of claim 1, wherein support polymeric film layer (a) and/or second polymeric film layer (b) comprises polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, copolymers thereof, or mixtures thereof.

3. The optical element of claim 2, wherein support polymeric film layer (a) and/or second polymeric film layer (b) comprises cellulose acetate, cellulose diacetate, cellulose triacetate, cellulose acetate propionate, and/or cellulose acetate butyrate.

4. The optical element of claim 1, wherein the second polymeric film layer (b) is photochromic and/or linearly polarizing.

5. The optical element of claim 4, wherein the second polymeric film layer (b) is photochromic and comprises a photochromic material comprising naphthopyrans, oxazines, phenanthropyrans, benzopyrans, metal-dithiozonates; fulgides, and/or fulgimides.

6. The optical element of claim 4, wherein the support polymeric film layer (a) and/or the second polymeric film layer (b) comprises cellulose acetate, cellulose diacetate, cellulose triacetate, cellulose acetate propionate, cellulose acetate butyrate, or mixtures thereof.

7. The optical element of claim 4, wherein the second polymeric film layer (b) is linearly polarizing and comprises a film material comprising
a polymeric component comprising poly(vinyl alcohol), poly(vinyl butyral), polyethylene terephthalate, cellulose acetate butyrate, cellulose acetate proprionate, cellulose acetate, cellulose diacetate, cellulose triacetate, polyurethane, polyether, polyester, polyamide, polyalkyl(meth)acrylate, copolymers thereof, or mixtures thereof; and
a dichroic material.

8. The optical element of claim 4, wherein the second polymeric film layer (b) is linearly polarizing and comprises a film material comprising
a polymeric component comprising oriented film of polyvinyl alcohol, vinyl butyral, polyethylene terephthalate, polyalkyl(meth)acrylate, polyamide, poly(amide-ether) block copolymers, poly(ester-ether) block copolymers, poly(ether-urethane) block copolymers, poly(ester-urethane) block copolymers, and/or poly(ether-urea) block copolymers; and
a dichroic material.

9. The optical element of claim 7, wherein the dichroic material comprises azomethines, indigoids, thioindigoids, merocyanines, indans, quinophthalonic dyes, perylenes, phthaloperines, triphenodioxazines, indoloquinoxalines, imidazo-triazines, tetrazines, azo and (poly)azo dyes, benzoquinones, naphthoquinones, anthroquinone, (poly)anthroquinones, anthropyrimidinones, iodine, and/or iodates.

10. The optical element of claim 7, wherein the dichroic material comprises a photochromic-dichroic compound.

11. The optical element of claim 7, wherein the dichroic material comprises a K-type polarizer.

12. The optical element of claim 8, wherein the dichroic material comprises azomethines, indigoids, thioindigoids, merocyanines, indans, quinophthalonic dyes, perylenes, phthaloperines, triphenodioxazines, indoloquinoxalines, imidazo-triazines, tetrazines, azo and (poly)azo dyes, benzoquinones, naphthoquinones, anthroquinone, (poly)anthroquinones, anthropyrimidinones, iodine, and/or iodates.

13. The optical element of claim 8, wherein the dichroic material comprises a photochromic-dichroic compound.

14. The optical element of claim 8, wherein the dichroic material comprises a K-type polarizer.

15. The optical element of claim 7, wherein the support polymeric film layer (a) comprises cellulose acetate, cellulose diacetate, cellulose triacetate, cellulose acetate propionate, and/or cellulose acetate butyrate.

16. The optical element of claim 8, wherein support polymeric film layer (a) comprises cellulose acetate, cellulose diacetate, cellulose triacetate, cellulose acetate propionate, and/or cellulose acetate butyrate.

17. The optical element of claim 1 wherein the film material comprising the support polymeric film layer (a) and the film material comprising the second polymeric film layer (b) are different.

18. The optical element of claim 1, wherein the film material comprising the support polymeric film layer (a) and the film material comprising the second polymeric film layer (b) are the same.

19. The optical element of claim 1, further comprising protective polymeric film layer (d) having opposing first and second sides, wherein the second side of protective polymeric film layer (d) is connected to at least a portion of the first side of the second polymeric film layer (b).

20. The optical element of claim 19, wherein protective polymeric film layer (d) comprises polycarbonate, polycyclic alkene, polyurethane, poly(urea)urethane, polythiourethane, polythio(urea)urethane, polyol(allyl carbonate), cellulose acetate, cellulose diacetate, cellulose triacetate, cellulose acetate propionate, cellulose acetate butyrate, poly(vinyl acetate), poly(vinyl alcohol), poly(vinyl chloride), poly(vinylidene chloride), poly(ethylene terephthalate), polyester, polysulfone, polyolefin, copolymers thereof, or mixtures thereof.

21. The optical element of claim 20, wherein protective polymeric film layer (d) comprises cellulose acetate butyrate, cellulose acetate propionate, cellulose acetate, cellulose diacetate, and/or cellulose triacetate.

22. The optical element of claim 20, wherein protective polymeric film layer (d) further comprises a protective coating comprising abrasion-resistant coatings, oxygen barrier-coatings, UV-shielding coatings, anti-reflective coatings, anti-fogging coatings, mirror coatings, or combinations thereof, connected to at least a portion of the first side of protective layer (d).

23. The optical element of claim 1, wherein the first side of support polymeric film layer (a) is connected directly to the second side of second polymeric film layer (b).

24. The optical element of claim 23, further comprising a protective coating comprising abrasion-resistant coatings, oxygen barrier-coatings, UV-shielding coatings, anti-reflective coatings, anti-fogging coatings, mirror coatings, or combinations thereof, connected to at least a portion of the first side of second polymeric film layer (b).

25. The optical element of claim 1 wherein the optical element comprises ophthalmic elements, display elements, windows, mirrors, and/or active and passive liquid crystal cell elements and devices.

26. The optical element of claim 25, wherein the ophthalmic element comprises corrective lenses, non-corrective lenses, contact lenses, intra-ocular lenses, magnifying lenses, protective lenses, or visors.
